(19) United States
(12) Patent Application Publication
(10) Pub. No.: US 2008/0315113 A1
(43) Pub. Date: Dec. 25, 2008

(54) BEAM GUIDANCE MAGNET

(76) Inventors: Dirk Diehl, Erlangen (DE); Rene Gumbrecht, Herzogenaurach (DE); Eva Schneider, Nurnberg (DE)

Correspondence Address: BRINKS HOFER GILSON & LIONE, P.O. BOX 10395, CHICAGO, IL, 60610, US

(21) Appl. No.: 12/138,774

(22) Filed: Jun. 13, 2008

(30) Foreign Application Priority Data
Jun. 21, 2007 (DE) 10 2007 028 646.7

(51) Int. Cl. H01J 3/14

(52) U.S. Cl. 250/398

(57) ABSTRACT

A beam guidance magnet for deflecting a beam of electrically charged particles along a curved particle path is provided. The beam guidance magnet includes a coil system that does not include a ferromagnetic material affecting the beam guidance and has curved coils stretched out along the particle path, the coils being arranged in pairs in mirror symmetry to the beam guidance plane. The coil system includes two primary coils and two substantially flat secondary coils. The two primary coils include primary coil sides and primary coil end parts bent upward relative to the beam guidance plane. The two substantially flat secondary coils are disposed between the primary coil end parts. Supplementary coils are disposed in the field range of the respective curved secondary coil end parts.

This application claims the benefit of DE 10 2007 028 646.7 filed Jun. 21, 2007, which is hereby incorporated by reference.

### BACKGROUND

The present embodiments relate to a beam guidance magnet.

A beam guidance magnet is used to deflect a beam along a curved beam path.

Curved beam guidance magnets are used in particle accelerator systems for deflecting and/or focusing a beam of charged particles, such as electrons or ions. The particles are accelerated to high kinetic energies in the particle accelerator system and are used in medical therapy, such as cancer therapy. German Patent Application DE 199 04 675 A1 and U.S. Pat. No. 4,870,287 A disclose a radiation treatment system for medical therapy. The radiation treatment system includes a particle source and an accelerator for generating a high-energy particle beam. The high-energy particle beam is aimed at a region to be irradiated, such as a tumor, of a test subject. The radiation dose in the surrounding area, which is the area not to be treated, of the body (patient) should be kept as slight as possible (minimized). To keep the radiation dose slight in the region not to be treated, the region to be treated is irradiated from various directions. The particle beam is shot (directed) along an axis, predetermined by the accelerator, into a so-called “gantry,” which is rotatable about the axis predetermined by the particle beam.

The “gantry” is an arrangement of various beam guidance magnets, with which the particle beam can be deflected multiple times out of its original direction, so that after leaving the gantry, it strikes the region to be irradiated at a certain angle. Typically, the particle beam strikes the region to be irradiated at an angle of 45° to 90°, relative to the axis of rotation of the gantry. The beam guidance magnets are disposed on a frame, which is part of the gantry, in such a way that the particle beam emerging from the gantry always passes through a certain region, the so-called “isocenter”. A region to be treated can be irradiated from a plurality of sides. In a region lateral to the particle beam, the isocenter has an area of 20×20 cm, for example. The radiation dose in the region surrounding the isocenter may be distributed over a large volume, and the radiation exposure outside the isocenter may be relatively slight (minimized).

For irradiating a spatially extensive tumor or growth, a variation in the angle at which the particle beam strikes the region to be irradiated, a variation of the kinetic energy of the particles, and a variation of the lateral location coordinates at the point struck by the particle beam are desirable. For varying the lateral location coordinates of the particle beam at the site of the isocenter, scanner magnets are typically integrated with the gantry. With the aid of the scanner magnets, the particle beam can be deflected in a horizontal or vertical plane, by small angles. The deflections of the particle beam caused by the scanner magnets are compensated for in such a way that the particle beam leaves the gantry in beams into the isocenter that are to be made virtually parallel. The magnets following the scanner magnets in the beam direction compensate for the deflections.

For varying the kinetic energy of the particles, the particles originating at the particle source are shot (directed) into a gantry at different kinetic energies. Depending on the desired kinetic energy of the particles shot into the gantry, the individual magnets of the gantry are excited to suitable energies.

Because of the aforementioned conditions placed on the magnets of a gantry, ion-optical demands are made in terms of the construction of the beam guidance magnets. Coil designs are optimized in view of the criteria.

The magnetic flux density increases to very high values at the end regions of a beam guidance magnet. The end regions may be arches of the curved primary and/or correction coils. Accordingly, the magnetic flux density increases because of the small radii of curvature. If the coils of the beam guidance magnets are made in superconducting fashion, this technical problem is exacerbated, since the magnetic fields that occur in the end regions of the coils can be greater than the critical magnetic flux density of the superconductor material.

German Patent Application DL 199 04 675 A1 discloses reducing the supercritical magnetic flux densities in the end region of the individual coils of a beam guidance magnet. For example, German Patent Application DE 199 04 675 A1 discloses bending the end parts of the primary coils upward relative to the beam guidance plane by more than 90°. The end parts extend into the field range of the respective curved end part of the respective associated secondary coil.

German Patent Application DE 199 04 675 A1 discloses a beam guidance magnet that can avoid the occurrence of supercritical magnetic fields in the curved end parts of the secondary coils. Magnetic fields in the curved end parts of the secondary coils can be avoided that exceed maximum limit values, which are predetermined by the material used to construct the beam guidance magnet. Particularly in a beam guidance magnet with superconducting coils, exposing the superconductor material to a supercritical magnetic field, which causes the superconductor material above this supercritical magnetic field to lose its superconducting properties, can be avoided. The critical magnetic field of the corresponding superconductor material is dependent on the current carried by the superconducting material. In accordance with the aforementioned provisions, a predetermined current-carrying capacity of the superconductor material can expose the material solely to a suitably subcritical magnetic field. The beam guidance magnet is improved with regard to its reliability, without requiring oversizing of its conductor material.

German Patent Application DE 199 04 675 A1 discloses a beam guidance magnet that can reduce the field to which the curved end parts of the secondary coils are exposed. In addition to the ion-optical demands to be made of the beam guidance magnet, however, limits can be set on an embodiment of the end parts of the primary coils of the proposed beam guidance magnet. For ion-optical reasons, for example, optimal field compensation for the end parts of the primary coils may not be achieved. The proposed beam guidance magnet can keep a stray field as small as possible in a patient room.

### SUMMARY AND DESCRIPTION

The present embodiments may obviate one or more of the drawbacks or limitations inherent in the related art. For example, in one embodiment, a beam guidance magnet reduces the aforementioned problems.

German Patent Application 10 2007 025 584.7, which was filed Jun. 1, 2007 and not published prior to the priority date of the present application and is entitled “Strahlführungsmagnet zur Ablenkung eines Strahls elektrisch geladener Teilchen längs einer gekrümmten Teilchenbahn und Bestrahlungsanlage mit einem solchen Magneten” [“Beam Guidance Magnet for Deflecting a Beam of Electrically Charged Particles Along a Curved Particle Path, and Radiation Treatment System Having Such a Magnet”], discloses a beam guidance magnet for deflecting a beam of electrically charged particles along a curved particle path that defines a beam guidance plane. The beam guidance magnet includes a coil system, which does not include ferromagnetic material that affects the beam guidance. The coil system has curved individual coils stretched out along the particle path. The individual coils are disposed in pairs in mirror symmetry to the beam guidance plane. The coil system includes at least two primary coils with side parts elongated in the direction of the particle path and with end parts bent upward relative to the beam guidance plane. The coil system includes two at least largely flat secondary coils, curved in bananalike (crescentlike) shape, between the end parts of the primary coils and having side parts, elongated in the direction of the particle path, and curved end parts.

In one present embodiment, a beam guidance magnet includes supplementary coils, which are disposed in the field region of the respective curved end parts of the secondary coils. The beam of electrically charged particles may be deflected into an elongated patient room, with compensation coils located on both sides of the elongated patient room.

The supplementary coils may reduce the field to which the curved end parts of the primary coils are exposed. The supplementary coils may, for example, be controlled separately from the remaining coil system of the beam guidance magnet, so that optimal compensation of the magnetic fields can be achieved. Ion-optical demands of the beam guidance magnet may be taken into account, without dispensing with a suitable field compensation in the region of the curved end regions of the primary coils. The stray field of the beam guidance magnet in the patient room may be actively compensated for in the compensation coils disposed on both sides of an elongated patient room. For various medical and technical reasons, low exposure of the patient room to the stray field of the beam guidance magnet is desirable. The field of use for the beam guidance magnet expands, for example, to patients who have electromagnetically sensitive devices implanted in their body.

The supplementary coils may extend in one or more planes parallel to the beam guidance plane. The supplementary coils may be arranged (disposed) in one or more planes parallel to the beam guidance plane. The supplementary coils arranged (disposed) in one or more planes parallel to the beam guidance plane may compensate for the stray field of the beam guidance magnet.

The compensation coils may extend in a plane or planes that are parallel to the beam guidance plane. Because the compensation coils are disposed parallel to the beam guidance plane, especially effective field compensation in the patient room may be attained.

The end parts of the primary coils may be bent (curved) upward in such a way that in projection into the beam guidance plane, the end parts of the primary coils and the curved end parts of the secondary coils overlap. An overlap of the end parts of the primary coils and of the curved end parts of the secondary coils in projection into the beam guidance plane may generate a region in the applicable area of the overlap with effective compensation of the magnetic fields.

The end parts of the primary coils may be bent upward by approximately 180° relative to the beam guidance plane. The end parts of the primary coils may (e.g., at least approximately) be located in a plane that is at least approximately parallel to a plane, which is defined by the respective curved end part of the associated secondary coil. If the end parts of the primary coil are bent upward by approximately 180° relative to the beam guidance plane, then the magnetic field generated by the end parts of the primary coil has (e.g., virtually, solely) a magnetic field component that is exactly opposite in its direction to the magnetic field, which is generated by the curved end parts of the associated secondary coil. The magnetic field generated by the end parts of the primary coil may compensate for the magnetic fields of the end parts of the primary coils and the end parts of the secondary coils.

The coil system may include first and second coil systems for generating a first and second dipole moment. The first coil system may include at least the two primary coils with the bent-upward end parts as first primary coils and the two at least largely flat secondary coils. The secondary coils may enclose an inner region in which at least one largely flat correction coil curved in banana-like (crescent-like) shape is disposed. The second coil system may include two second primary coils curved in banana-like (crescent-like) shape, which are each disposed in the region of the beam guidance plane between the first primary coils and have one elongated second side part near the particle path and one elongated second side part remote from the particle path. When viewed in cross section, the side parts may have a greater length perpendicular to the beam guidance plane than parallel to the beam guidance plane. The first and second coil systems may be excited such that the first and second dipole moments point in opposite directions or at least approximately opposite directions. A beam guidance magnet with a coil system may include a reduced stray field. A beam guidance magnet with a reduced stray field may be powerful beam guidance magnets, in which the occurrence of high magnetic fields in the curved end parts of the secondary coils is especially dominant. For powerful beam guidance magnets, the high magnetic fields occurring at the curved end parts of the secondary coils can be compensated for with the coil system.

The first and second coil systems may be excited in such a way that in the outside region of the beam guidance magnet, the sum of the dipole moments of the first and second coil systems is minimized. Minimizing the stray field of a beam guidance magnet improves electromagnetic compatibility. The high magnetic fields in the curved end parts of the secondary coils may be minimized.

The beam of electrically charged particles may be deflected along a curved particle path into an isocenter. The sum of the dipole moments of the first and second coil systems may be minimized at least at the site of the isocenter. If a beam guidance magnet is used for therapeutic purposes, then the region to be treated may be located at the site of the isocenter. The beam guidance magnet, because of its reduced stray field, may be accessible to (used for) medical applications in which an electromagnetically sensitive device, such as a pacemaker, is located at or in the vicinity of the isocenter. For therapeutic purposes, such as ion therapy, powerful magnets are typically used. Powerful magnets have elevated magnetic fields in the curved end parts of the secondary coils. For a powerful beam guidance magnet, the elevated magnetic fields in the curved end parts of the secondary coils may be reduced.

The individual coils of the first and second coil systems may be connected electrically in series. The number of windings of the individual coils may be dimensioned such that the sum of the dipole moments of the first and second coil systems is minimized. The individual coils of the first and second coil systems may be connected electrically in series, and the surface area enclosed by the second primary coils in the beam guidance plane may be dimensioned such that the sum of the dipole moments of the first and second coil systems is minimized. A beam guidance magnet may be improved with regard to a minimized stray field and with regard to the occurrence of maximum magnetic field exposures.

The conductors of the individual coils may have metal low-temperature superconductor material (“LTC superconductor material”) or metal oxide high-temperature superconductor material (“HTC superconductor material”). The metal oxide high-temperature superconductor material may be kept at (maintained) an operating temperature between 10K and 40K, preferably at an operating temperature between 20K and 30K. If a beam guidance magnet is made with superconducting coils, then the problem of the occurrence of supercritical magnetic fields in the curved end parts of the secondary coils is especially critical. A superconductor material, above a material-specific critical magnetic field, loses its superconducting properties. If the occurrence of supercritical magnetic fields can be avoided, then the beam guidance magnet may be improved in terms of its reliability.

A radiation treatment system may have a fixed particle source that generates a beam of electrically charged particles. The radiation treatment system may have a gantry system, which is rotatable about an axis of rotation and has a plurality of deflection and/or focusing magnets for deflecting and/or focusing the particle beam into an isocenter. At least one of the deflection and/or focusing magnets is a beam guidance magnet in accordance with one of embodiments disclosed herein.

The radiation treatment system may include a beam guidance magnet in accordance with one of the aforementioned embodiments as the deflection and/or focusing magnet through which the particle beam passes last before reaching the isocenter. The deflection and/or focusing magnet of a radiation treatment system through which the particle beam passes last before reaching the isocenter is typically a high-power beam guidance magnet. The beam guidance magnet may reduce the occurrence of superelevated magnetic fields in the curved end parts of the secondary coils.

The radiation treatment system may have a beam guidance magnet whose stray field is minimized in a patient room, preferably at least at the site of the isocenter. Minimizing the stray field of the beam guidance magnet in the patient room, preferably at the site of the isocenter, may improve the electromagnetic compatibility of the radiation treatment system. The beam guidance magnet of the radiation treatment system may reduce the occurrence of supercritical magnetic fields in the curved end parts of the secondary coils.

The particle beam may be a beam comprising C⁶⁺ particles. C⁶⁺ particles may be used for cancer therapy. Such radiation treatment systems used in medical technology are radiation treatment systems with high-power deflection and/or focusing magnets. A radiation treatment system with high-power deflection and/or focusing magnets may include at least one beam guidance magnet that reduces the superelevated magnetic fields in the curved end parts of the secondary coils.

### BRIEF DESCRIPTION OF THE DRAWINGS

FIG. 1 illustrates one embodiment a radiation treatment system with a gantry system;

FIG. 2 illustrates one embodiment of a beam guidance magnet;

FIG. 3 illustrates another embodiment of a beam guidance magnet;

FIG. 4 illustrates the beam guidance magnet of FIG. 3 in a projection into the beam guidance plane; and

FIG. 5 illustrates one embodiment of a beam guidance magnet with supplementary coils and compensation coils as part of a radiation treatment system.

### DETAILED DESCRIPTION

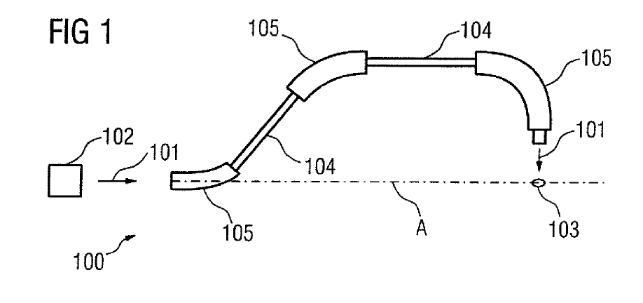

FIG. 1 shows a radiation treatment system 110. The radiation treatment system 110 includes a beam of electrically charged particles 101, originating at a particle source 102, which may be deflected along a curved particle path with the aid of a gantry system. The particle beam 101 may be a beam of C⁶⁺ ions. With the aid of the gantry system, the particle beam 101 originating in the particle source 102 is deflected into an isocenter 103. A plurality of deflection and/or focusing magnets 105 may deflect the particle beam 101, which is guided inside the gantry system in a beam guidance tube 104. The gantry system that surrounds the deflection and/or focusing magnets 105 is rotatable about an axis of rotation A, which may be predetermined by the particle source 102. The gantry system includes the plurality of deflection and/or focusing magnets 105; a frame for mounting the deflection and/or focusing magnets; bearing devices; a cooling system for cooling the deflection and/or focusing magnets 105; and other components for the operation of the gantry.

The gantry system may deflect the particle beam 101 into the isocenter 103. The isocenter 103 is the region in which the particle beam 101 intersects the axis of rotation A of the gantry. Upon a rotation of the gantry system about the axis of rotation A, the particle beam 101 always (or almost always) passes through the isocenter 103.

A gantry system may be used for medical therapy. A region to be treated, such as a tumor or growth that is to be irradiated, will be located in the region of the isocenter 103. A beam of C⁶⁺ ions may be used for medical treatment.

The deflection and/or focusing magnets 105 of a radiation treatment system 100 may have magnetic windings that are made from normally conducting material, or from superconductor material.

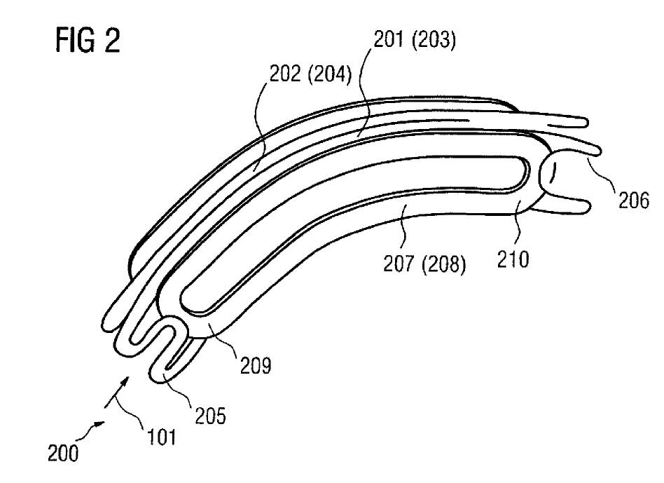

FIG. 2 shows a portion of a beam guidance magnet 200. The beam guidance magnet 200 shown in FIG. 2 may be a deflection and/or focusing magnet 105 which is part of a radiation treatment system 100. The beam guidance magnet 200 may have a first and a second primary coil 201, 202, which have side parts 203 and 204, respectively, extending along a particle path. The primary coils 201, 202 may be arranged in pairs, for example, in mirror symmetry to a beam guidance plane that is defined by the particle path of the beam of electrically charged particles 101. The two primary coils 201, 202 may have respective end parts 205, 206 adjoining the elongated side parts 203, 204. For simplicity in FIG. 2, only the bent-upward end parts 205, 206 of the primary coil 201 are shown. The bent-upward end parts 205, 206 are bent (curved) upward relative to the beam guidance plane that is defined by the beam of electrically charged particles 101. The end parts 205, 206 may be bent upward by more than 90° relative to the beam guidance plane.

Between the end parts 205, 206 of each of the primary coils 201, 202 is a respective largely flat secondary coil 207 curved in a banana-like (crescent-like) shape. The secondary coils 207 have side parts 208, elongated in the direction of the particle path, and curved end parts 209, 210.

The bent-upward end parts 205, 206 of the primary coils 201, 202 are bent upward out of the beam guidance plane in such a way that bent-upward end parts 205, 206 extend into the field range of the associated end parts 209, 210 of the secondary coils 207. In the exemplary embodiment shown in FIG. 2, the bent-upward end part 205 of the primary coil 201, for example, extends into the field range of the end part 209 of the secondary coil 207.

The beam guidance magnet 200 may be free of ferromagnetic material that affects the beam guidance. The beam guidance magnet 20 may not include magnetic field-forming material, such as iron yokes.

The end parts 205, 206 of the primary coils 201, 202 may be bent upward by more than 90° out of the beam guidance plane. The end parts 205, 206 of the primary coils 201, 202 may be bent upward at least approximately 180° relative to the beam guidance plane. The end regions 205, 206 of the primary coils 201, 202 may be located in a plane that is at least approximately parallel to the beam guidance plane. If the end parts 205, 260 of the primary coils 201, 202 are bent upward by more than 90° from the beam guidance plane, then the magnetic field generated by the end parts 205, 206 has a magnetic field component that is perpendicular to the beam guidance plane. The magnetic field component that is perpendicular to the beam guidance plane compensates at least partially for the magnetic field generated by the curved end parts 209, 210 of the secondary coils 207. If the end parts 205, 260 of the primary coils 201, 202 are bent upward by approximately 180° from the beam guidance plane, then the magnetic field generated by the end parts 205, 206 has a magnetic field component that is perpendicular to the beam guidance plane. Since the magnetic field component, which is perpendicular to the beam guidance plane and is generated by the end parts 205, 260 of the primary coils 201, 202, has a direction which is the direction of the magnetic field that is generated by the curved end parts 209, 210 of the secondary coils 207, the corresponding magnetic fields compensate for one another at least partially.

The beam guidance magnet 200 may have individual coils whose conductors are made at least predominantly from metal low-temperature superconductor material (“LTC superconductor material”). The beam guidance magnet 200 may have individual coils whose conductors have metal oxide high-temperature superconducting material (“HTC superconductor material”). The high-temperature superconductor material may include, for example, yttrium barium copper oxide “YBCO”. The operating temperature of conductors of the individual coils comprising a high-temperature superconductor material may be between approximately 10K and 40K, and preferably between 20K and 30K. A beam guidance magnet 200 that is equipped with superconducting individual coils may include a cooling system for cooling the superconducting individual coils.

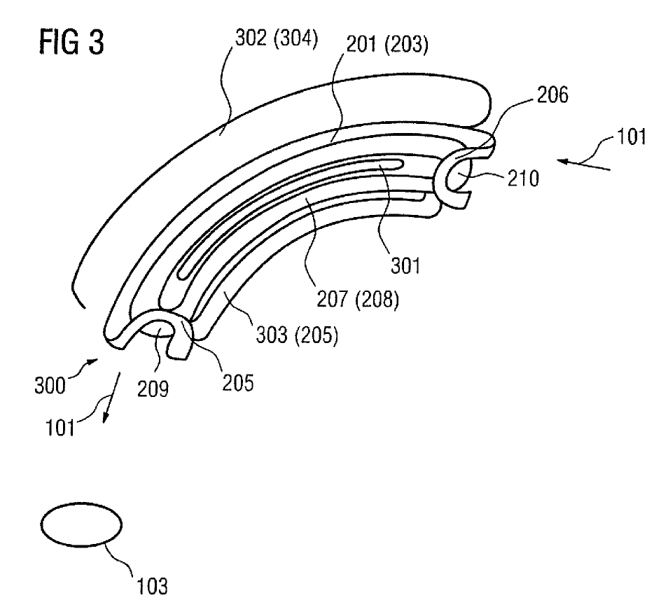

FIG. 3 shows a guidance magnet 300, which is subdivided into a first and a second coil system. The first and second coil system may generate a first and second dipole moment, which at least approximately point in opposite directions. The first coil system includes two primary coils 201 and two at least largely flat secondary coils 207. For the sake of simplicity, in FIG. 3 only one of the two primary coils and one of the two secondary coils are shown. The secondary coils 207 each enclose a respective inner region, in which an at least largely flat correction coil 301, curved in banana-like shape, is disposed. The second coil system includes two second primary coils 302, 303 curved in banana-like shape, which each have one elongated second side part 304 near the particle path and an elongated second side part 305 remote from the particle path. Viewed in cross section, such as a section perpendicular to the beam guidance plane, the elongated side parts 304, 305 may have a greater length perpendicular to the beam guidance plane than parallel to the beam guidance plane.

The first and second coil systems may be excited such that the dipole moment of the first coil system and the dipole moment of the second coil system at least approximately compensate for one another. The first and second coil systems may be excited such that in the remote field of the beam guidance magnet 300, the sum of the dipole moments of the first coil system and second coil system is minimized. A quadrupole moment, viewed from the site where of its generation, drops off faster than a dipole moment. Since the dipole moments of the first and second coil system at least partially compensate for one another, the beam guidance magnet 300 of the exemplary embodiment shown in FIG. 3 has essentially a quadruple moment. Since the quadruple moment drops off faster in space, a beam guidance magnet 300 has a minimized stray field.

The beam guidance magnet 300 of the exemplary embodiment shown in FIG. 3 may be a deflection and/or focusing magnet through which a beam of electrically charged particles 101 passes last before the beam of electrically charged particles 101 strikes an isocenter 103 (e.g., see FIG. 1).

The beam guidance magnet 300 in the exemplary embodiment shown in FIG. 3 may be embodied such that the first and second coil systems are excited in such a manner that the dipole moment of the beam guidance magnet 300 is minimized at the site of the isocenter 103. The beam guidance magnet 300 may be used in medical technology. For example, an area to be treated will be located in the region of the isocenter 103. A beam guidance magnet with a reduced stray field may be used for a medical application such as for irradiating patients who have electromagnetically sensitive medical devices (such as a pacemaker) implanted in their body.

The dipole moments generated by the first and second coil systems may compensate for one another. The individual coils of the first and second coil systems may be connected electrically in series, and the number of windings in the individual coils of the first and second coil systems may be dimensioned such that the sum of the dipole moments of the first and second coil systems is minimized. Alternatively, the individual coils of the first and second coil systems can be connected electrically in series, and the second primary coils 203 may enclose an area inside the beam guidance plane that is dimensioned such that the sum of the dipole moments of the first and second coil systems is minimized.

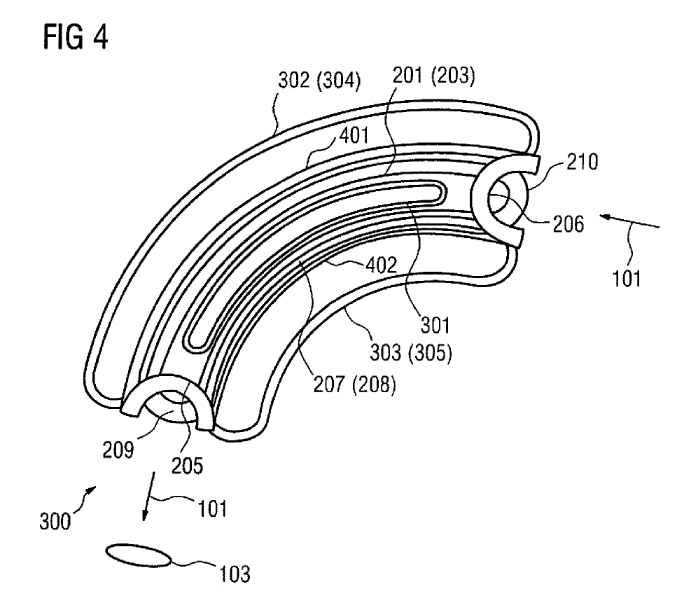

FIG. 4 shows the beam guidance magnet 300, shown in FIG. 3, in a projection into the beam guidance plane. In FIG. 4, the individual coils of the first and second coil systems are shown. The first coil system includes two primary coils 207; in FIG. 4, only one of the two primary coils is shown, and the corresponding second primary coil, which is disposed mirror-symmetrically to the beam guidance magnet, would come to be congruent with the first. The first primary coils 201 each have bent-upward end parts 205, 206. The secondary coils 207 are located between the bent-upward end parts 205, 206. The primary coils 201 each have side parts 203, elongated along the particle path, and the secondary coils 207 each have largely flat, elongated side parts 208.

The second coil system includes two second primary coils 302, 303, which are each curved in banana-like shape and are disposed in the region of the beam guidance plane between the first primary coils 201. The two second primary coils 302, 303 each have one partial piece 401 near the particle path and one side part 304, 305 remote from the particle path. As shown in FIG. 4, the first coil system could generate a dipole moment which points out of the plane of the paper, while the second coil system generates a dipole moment which points into the plane of the paper. An orientation rotated by 180° each is naturally also possible.

The coil system shown in FIG. 4 may include the first and second coil systems and correction coils 301 disposed in the inner region of the secondary coil. A beam of electrically charged particles 101 may be deflected into and isocenter 103 by the coil system shown in FIG. 4.

The end parts 205, 206 of the primary coils 201, 202 may be bent upward in such a way that the end parts 205, 206 overlap with the curved end parts 209, 210 of the secondary coils 207 in the projection into the beam guidance plane.

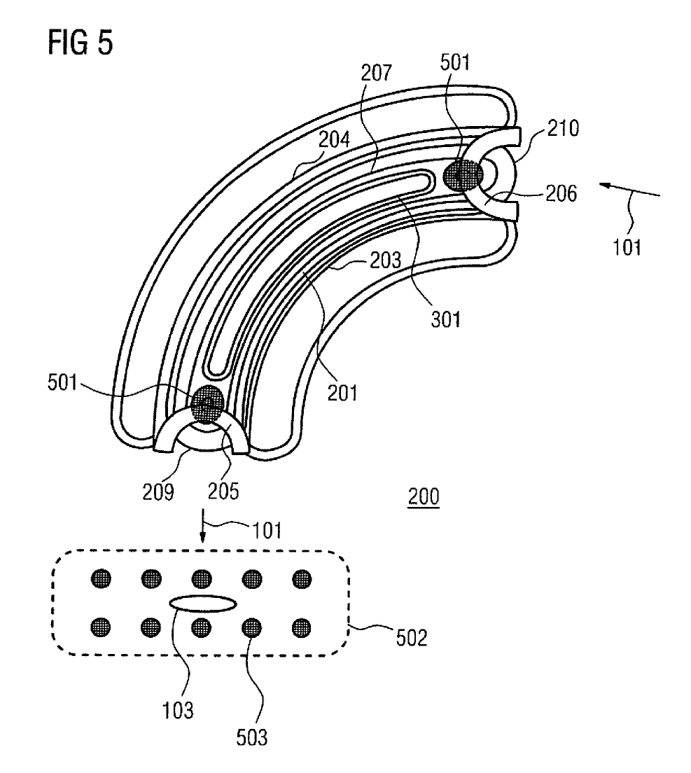

FIG. 5 shows a beam guidance magnet 200 in one exemplary embodiment. The beam guidance magnet 200 has the primary coils already known from the exemplary embodiments described above, of which only one primary coil 201 is shown, with end parts 205, 206. A curved secondary coil 207 with curved end parts 209, 210 extends between the end parts 205, 206 of the primary coil 201. In the inner region of the secondary coil 207 is a correction coil 301. Respective supplementary coils 501 are located in the region of each of the curved end parts 209, 210 of the secondary coil 207. The supplementary coils 501 may be triggerable separately from the rest of the coil system of the beam guidance magnet 200. The supplementary coils 501 may be excited in such a way that effective magnetic field compensation in the region of the curved end parts 209, 210 of the secondary coils 207 may be attained.

With the beam guidance magnet 200 shown in FIG. 5, a beam 101 of electrically charged particles may be deflected into an isocenter 103. The isocenter 103 may be located inside an elongated patient's room 502. Compensation coils 503 may be located on both sides of this elongated patient room 502. The compensation coils 503 may reduce the stray field of the beam guidance magnet 200 and possibly minimize the stray field in the region of the patient room 502.

The supplementary coils 501 and/or the compensation coils 403 may be made from normally conducting material or from superconductor material and can be triggerable or excitable individually or jointly with the rest of the coil system of the beam guidance magnet 200.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A beam guidance magnet for deflecting a beam of electrically charged particles along a curved particle path that defines a beam guidance plane, the beam guidance magnet comprising:
a coil system that does not include a ferromagnetic material affecting the beam guidance and that has curved coils stretched out along the particle path, the coils being arranged in pairs in mirror symmetry to the beam guidance plane, the coil system comprising:
two primary coils that include primary coil sides, elongated in the direction of the particle path, and primary coil end parts bent upward relative to the beam guidance plane, and
two substantially flat secondary coils, curved in a banana-like shape, disposed between the primary coil end parts, the two substantially flat secondary coils having secondary coil sides, elongated in the direction of the particle path, and curved secondary coil end parts, and
wherein the primary coil end parts are bent upward relative to the beam guidance plane by more than 90° in such a manner that they extend into a field range of the respective curved secondary coil end part, and
wherein supplementary coils are disposed in the field range of the respective curved secondary coil end parts.

2. The beam guidance magnet as defined by claim 1, wherein the secondary coils extend in one or more planes parallel to the beam guidance plane.

3. A beam guidance magnet for deflecting a beam of electrically charged particles along a curved particle path that defines a beam guidance plane, the beam guidance magnet comprising:
a coil system that does not include a ferromagnetic material, the coil system having curved individual coils stretched out along the particle path that are each arranged in pairs in mirror symmetry to the beam guidance plane, the coil system including at least:
two primary coils with primary side parts, elongated in the direction of the particle path, and with primary end parts bent upward relative to the beam guidance plane, and
two substantially flat secondary coils, curved in banana-like shape, disposed between the primary end parts and secondary side parts, elongated in the direction of the particle path, and curved secondary end parts, and
wherein the primary end parts are bent upward relative to the beam guidance plane by more than 90° in such a manner that they extend into the field range of the respective curved secondary end part of the respective associated secondary coil,
wherein the beam of electrically charged particles is deflected into an elongated patient room, and compensation coils are disposed on both sides of the elongated patient room.

4. The beam guidance magnet as defined by claim 3, wherein the compensation coils extend in one or more planes parallel to the beam guidance plane.

5. The beam guidance magnet as defined by claim 1, wherein the primary coil end parts are bent upward into the beam guidance plane, the primary coil end parts and the curved secondary coil end parts overlap.

6. The beam guidance magnet as defined by claim 1, wherein the primary coil end parts are bent upward relative to the beam guidance plane by approximately 180°, so that they are located in an at least approximately parallel plane to that of the respective curved secondary coil end part of the associated secondary coil.

7. A coil system for a beam guidance magnet, the coil system comprising:
a first coil system for generating a first dipole moment, the first coil system comprising:
two first primary coils with the bent-upward primary coil end parts and two at least substantially flat secondary coils, the secondary coils enclosing an inner region in which at least one largely flat correction coil, curved in a bananalike shape, is disposed, and
a second coil system that is operable to generate a second dipole moment, the second coil system comprising:
two second primary coils curved in a bananalike shape, which are each disposed in a region of a beam guidance plane between the first primary coils, the two second primary coils having a first elongated second side near a particle path and a second elongated second side remote from the particle path, the first and second elongated second sides have a greater length perpendicular to the beam guidance plane than parallel to the beam guidance plane,
wherein the first and second coil systems are operable to be excited in such a manner that the first and second dipole moments point in approximately opposite directions.

8. The coil system as defined by claim 7, wherein the first and second coil systems are excited in such a manner that in a region outside the beam guidance magnet, the sum of the dipole moments of the first and second coil systems is minimized.

9. The coil system as defined by claim 8, wherein a beam of electrically charged particles is deflected along a curved particle path into an isocenter, and the sum of the dipole moments of the first and second coil systems is minimized at the isocenter.

10. The coil system as defined by claim 8, wherein individual coils of the first and second coil systems are connected electrically in series, and a number of windings of the individual coils are dimensioned such that the sum of the dipole moments of the first and second coil systems is minimized.

11. The coil system as defined by claim 8, wherein the individual coils of the first and second coil systems are connected electrically in series, and the second primary coils in the beam guidance plane enclose a surface area dimensioned such that the sum of the dipole moments of the first and second coil systems is minimized.

12. The beam guidance magnet as defined by claim 1, wherein the curved coils include conductors that have metal low-temperature superconductor material.

13. The beam guidance magnet as defined by claim 1, wherein the curved coils include conductors that have metal oxide high-temperature superconductor material.

14. The beam guidance magnet as defined by claim 13, wherein the curved coils include conductors that have an operating temperature of between about 10K and 40K.

15. A radiation treatment system comprising:
a fixed particle source that is operable to generate a beam of electrically charged particles, and
a gantry system that is rotatable about an axis of rotation, the gantry including a deflection and/or focusing magnet for deflecting and/or focusing the particle beam into an isocenter,
wherein the deflection and/or focusing magnet is a beam guidance magnet that includes a coil system with first and second coil systems,
wherein the first and second coil systems are operable to be excited in such a manner that the first and second dipole moments point in approximately opposite directions.

16. The radiation treatment system as defined by claim 15, wherein the deflection and/or focusing magnet is a beam guidance magnet that the particle beam passes through last before reaching the isocenter.

17. The radiation treatment system as defined by claim 16, wherein the stray field of the beam guidance magnet is minimized at the isocenter.

18. The radiation treatment system as defined by claim 15, wherein the beam of electrically charged particles comprises C⁶⁺ particles.
